(19) United States
(12) Patent Application Publication
(10) Pub. No.: US 2009/0319380 A1
(43) Pub. Date: Dec. 24, 2009

(54) Facilitating Real Estate Transaction Collaboration

(76) Inventors: Rambod Jacoby, San Jose, CA (US); Jessica Esther Intrator, San Jose, CA (US)

Correspondence Address: MINTZ, LEVIN, COHN, FERRIS, GLOVSKY AND POPEO, P.C, 5 Palo Alto Square - 6th Floor, 3000 El Camino Real, PALO ALTO, CA, 94306-2155, US

(21) Appl. No.: 12/487,089

(22) Filed: Jun. 18, 2009

Related U.S. Application Data
(60) Provisional application No. 61/074,043, filed on Jun. 19, 2008.

(51) Int. Cl. G06Q 40/00; G06Q 30/00

(52) U.S. Cl. 705/14.73; 705/35

(57) ABSTRACT

The subject matter disclosed herein provides methods and apparatus, including computer program products, for facilitating collaboration between a variety of entities involved in real estate transactions. In one aspect there is provided a method. The method may include electronically receiving data from a plurality of users; calculating one or more buyer-personalized cash flow variables based on the received data; and providing an output, wherein the output includes the buyer-personalized cash flow variables formatted as a personalized monthly cash flow report.

### CROSS-REFERENCE TO RELATED APPLICATION

This application claims priority under 35 U.S.C. §119(e)(1) to United States Provisional Patent Application Ser. No. 61/074,043, filed Jun. 19, 2008, the entire contents of which (including the document attached thereto and titled “Real Estate Transaction Collaborator”) are incorporated herein by reference.

### FIELD

The subject matter described herein relates to facilitating collaboration between a variety of entities involved in real estate transactions to provide useful financial analyses to one or more of those entities.

### BACKGROUND

Any purchase of real estate requires a buyer to make a number of financial decisions based on a very large number of variables and options. The impact of a purchase on the buyer's financial situation is influenced by a number of factors, such as purchase price, property taxes, income tax deductions, mortgage interest rates, and mortgage type. Some of these factors have short-term implications, such as influencing the buyer's monthly cash flow, while others have long-term implications, such as influencing the projected length of time for paying off a mortgage. Some of these factors will have both long-term and short-term implications.

A typical buyer might view and consider several properties before deciding upon a property to purchase. The factors mentioned above will vary for each property under consideration, making it difficult for a buyer to accurately compare properties.

Furthermore, the data required to gauge the long-term and short-term implications of a property on a buyer's financial situation is supplied from a number of different sources. To have an accurate financial picture of a particular property for sale, a buyer must obtain information from one or more mortgage lender (e.g., current interest rates and available mortgage types) and a real estate agent (e.g., property purchase price, additional fees such as Home Owner's Association dues, and applicable property taxes). The buyer's taxable income from the previous year, monthly income, and expenses may be considered to account for items such as mortgage interest deductions. Obtaining all of the required information for each property under consideration is a time consuming, inefficient, and potentially inaccurate method for comparing property choices when making a purchase of real estate.

### SUMMARY

The subject matter disclosed herein provides methods and apparatus, including computer program products, for facilitating collaboration during a real estate transaction.

In one aspect, there is provided a method. The method may include electronically receiving data from a plurality of users. The data may be selected, for example, from buyer income, buyer expenditures, property price, mortgage interest rate, and mortgage term. The plurality of users may be selected, for example, from buyers, real estate agents, mortgage lenders, and financial advisors. As used herein the phrase “mortgage lender” includes anyone providing a mortgage, including a mortgage broker. The received data is used to calculate one or more buyer-personalized cash flow variables. Such variables may be selected, for example, from mortgage interest payments, real estate tax payments, property insurance payments, homeowner association payments, mortgage insurance premium payments, federal income tax benefits, state income tax benefits, and projected aggregate housing expenses. The calculated variables are used to provide an output comprising one or more of the buyer-personalized cash flow variables in a personalized monthly cash flow report.

In another aspect there may be provided a method. The method including electronically receiving one or more pieces of data selected from a buyer's income, the buyer's expenditures, the price of a property for sale, and the terms of a mortgage. The data is electronically stored in a data structure accessible to a plurality of users such that the plurality of users can add to or modify the data. The data is processed to calculate one or more cash-flow variables and to produce an output comprising the calculated cash-flow variables. Examples of suitable cash-flow variables include mortgage payments, real estate tax payments, property insurance payments, homeowner association dues, mortgage insurance payments, income tax benefits, and net monthly housing expenses.

Related systems, apparatus, methods, and/or articles are also described.

The details of one or more variations of the subject matter described herein are set forth in the accompanying drawings and the description below. Features and advantages of the subject matter described herein will be apparent from the description and drawings, and from the claims.

### DESCRIPTION OF THE DRAWINGS

In the drawings,

FIG. 1 depicts a block diagram of a system for facilitating collaboration;

FIG. 2 depicts a process for creating user accounts, processing of data, and generation of output;

FIG. 3 depicts a process for entering, processing, and outputting data; and

FIG. 4 depicts a process for facilitating collaboration.

Like labels are used to refer to same or similar items in the drawings.

### DETAILED DESCRIPTION

As used herein, the terms “cash flow” and “cash flow variables” are used interchangeably and are meant to refer to an entity's incoming money and outgoing payments. For example, incoming money typically include an individual's income from paychecks, tips, recurring subsidies and reimbursements, investment returns, and the like. Outgoing payments typically include an individual's housing expenses (e.g., rental payments and/or mortgage interest payments), taxes (e.g., income taxes and/or property taxes), other living expenses (e.g., food, transportation, and/or clothing), and the like. Such variables are typically measured on a monthly basis, but may be measured in any appropriate manner (e.g., weekly, yearly, etc). “Cash flow” and “cash flow variables” also include projections of net worth, such as how a client's net worth may increase over a period of time if he were to invest half of his salary into paying for a property that appreciates at 5% per year and the other half into a retirement account that appreciates 10% per year

A “cash flow report” refers to a compilation (e.g., a computer printout) providing selected cash flow variables.

As used herein, the term “property” and the phrase “real estate” are meant to include any type of residential property normally bought and sold, such as single family homes, town homes, condominiums, manufactured and mobile (i.e., trailer) homes, multi-family homes such as duplexes, triplexes, and four-plexes, farms, lots (i.e., undeveloped land), and the like.

The subject matter described herein facilitates collaboration between a variety of users involved (or potentially involved) in real estate transactions. As used herein, the phrase “real estate transaction” is meant to include purchases and sales of real estate, and is meant to apply to buyers and sellers who are at any stage in the process of purchasing real estate. Thus, a party involved in a real estate transaction includes a buyer who is represented by one or more service professionals (i.e., realtor, mortgage lender, financial advisor, etc.) and is actively involved in the purchase of a piece of real estate. A party involved in a real estate transaction also includes a potential buyer who is not represented by any service professionals but is merely interested in (or looking at) real estate.

In some implementations, there is provided a method for facilitating collaboration among entities involved in real estate transactions. Such entities are generally referred to herein as “users,” and the term is meant to include to any entity including an individual, a company, or a computer (e.g., a processor). For example, users may include buyers, mortgage lenders (i.e., loan officers), real estate agents, financial advisors, title officers, escrow officers, and the like. As used herein, the terms “buyer,” “purchaser,” and “client” are used synonymously, and are meant to include any persons involved in purchasing real estate, as well as persons potentially involved, desiring to become involved, or merely interested in purchasing real estate. Buyers may be further classified as “committed home buyers” (e.g., a buyer already working with a real estate agent or other professional user) or “available home buyers” (e.g., a buyer interested in purchasing a property but not yet working with a real estate agent or other professional user). As used herein, the phrase “professional user” is meant to include mortgage lenders, real estate agents, and financial advisors. The term “professional organization” is meant to include companies that employ professional users, such as mortgage brokers, real estate brokers, financial planning companies, and automated search engines.

The method may be implemented using “centralized implementation,” wherein a system is provided that includes a central computer server suitable for carrying out the methods described herein. Preferably, the server is connected to the internet, and is accessible from any computer appropriately connected to a network such as the internet According to this embodiment, each user is provided with a personal user account. For example, each professional user has an account, which is stored as a “user record” on the central computer server. Each committed and available home buyer has an account, which is stored as a “client record” on the server. Client records may be created by professional users, or they may be created when the buyer first accesses (i.e., “logs in to”) the server. Professional user records are created by authorized professional users, a site administrator, or may be created by professional users upon first accessing the server. Upon creation of a user record, many of the financial fields in the record are populated with default values as determined by an administrator.

User records and client records are data structures that allow data to be accessed by one or more users. For example, client record “A” may contain a field entitled “Name,” which contains the name of client “A.” As another example, client record “A” may contain a field entitled “lifestyle expenses,” which contains one or more numerical values representing the client's expenses. Client “A” has access to (and may therefore change the values stored in) this “lifestyle expenses” field. Any professional user with whom client “A” is collaborating will also have access to the “lifestyle expenses” field for client “A.” Furthermore, if any of the users with access to the “lifestyle expenses ” field for client “A” change the value stored in the field, all other users with access to the field will observe an identical change upon accessing the field. It will be appreciated that some fields may be visible but not editable for some users. For example, a professional user in a collaboration agreement with client A will be able to view client “A's” “Name” field, but may not be able to change the value stored in the field.

As mentioned previously, the systems and methods described herein facilitate collaboration among users. Collaboration occurs, for example, when data in a client record has a plurality of input sources. Such sources include the client to whom the client record belongs, the professional user responsible for creating the client record, and other professional users. For example, real estate agent “A” creates client record “A” for client “A” (at which point real estate agent “A” is said to be the “client owner” of client “A”). In creating the account, real estate agent “A” may enter any data that is available for client “A” at the time the account is created. In addition, real estate agent “A” may populate client record “A” with default industry specific data such as mortgage interest rates and investment rates of return from professional users such as mortgage lenders and financial planners that have chosen to collaborate with real estate agent “A”. After the account is created, any of the professional users that have chosen to collaborate with real estate agent “A” who have been granted access to the client record by real estate agent “A” (the client owner) may access client record “A” and change or add data in the fields that are not read-only for that professional user.

As described herein, each professional user may designate a plurality of other professional users with whom to collaborate. Collaboration among professional users may be governed, for example, by a collaboration table maintained on a central computer server. The collaboration table is a data store that contains a record for each professional user. A professional user's record contains identifying information (e.g., name and contact information) for other users that the professional user has selected as collaborating professionals. For example, real estate agent “A” may designate mortgage lenders “A” and “B” as well as financial planners “A” and “B” as collaborating professionals. Contact information for the four designated collaborating professionals are then added to real estate agent “A's” record in the collaboration table. Furthermore, the server creates links for each of these four collaborating professionals such that they appear as collaborating professionals in real estate agent “A's” user interface. Any of the collaborating professionals in real estate agent “A's” collaboration table record may be selected to collaborate with any of the clients owned by real estate agent “A.”

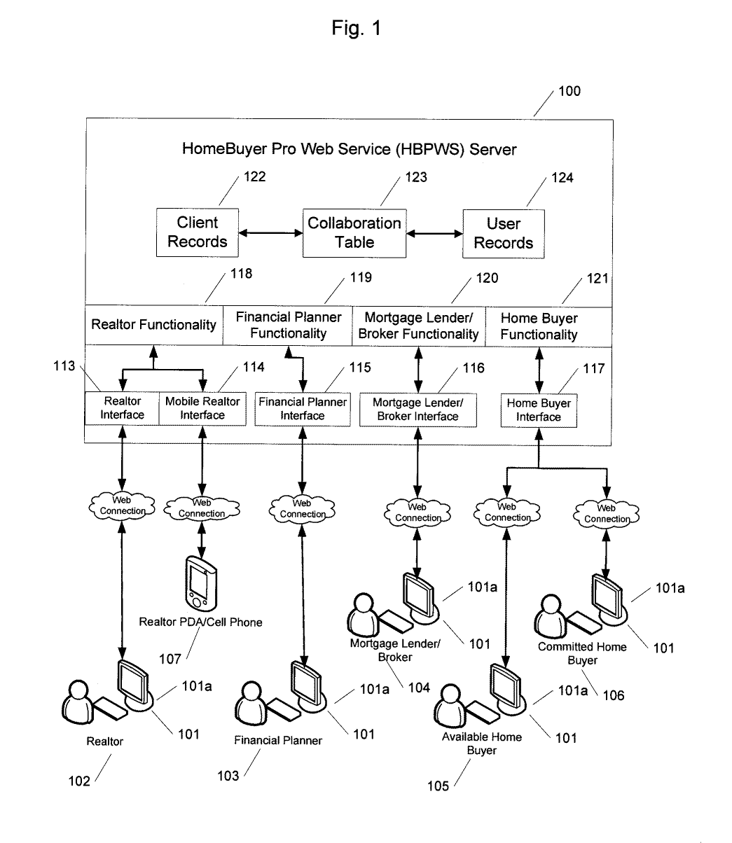

Referring now to FIG. 1, a system architecture is provided that depicts one example of the centralized implementation according to the present disclosure. Server 100 stores data, performs calculations, and generates output, thereby facilitating interaction among users of the system. Server 100 stores data including a collection of client records 122, a collection of user records 124, and a collaboration table 123, and is accessed using any computer terminal with an internet (“web”) connection.

Access of server 100 by a user may be facilitated via a user interface such as, for example, web browser 101a operating on computer 101. The user interface presents a webpage or a series of linked webpages that present relevant data and the tools that are available to the user. Such tools are generally accessed via buttons or tabs that are presented by the user interface.

Accessing server 100 may involve, for example, directing a web browser program on the computer terminal to a web address that affords access to server 100. The initial webpage accessing server 100 will generally allow a user to enter login information (e.g., user ID, password, etc.). The initial webpage may allow non-registered buyers (i.e., available home buyers) to access server 100 using a guest login, as described herein. The initial webpage may also allow non-registered professional users to create a new account on server 100.

Server 100 receives the login information and determines the identity of the user from a stored database of users. For example, realtor 102, financial planner 103, and mortgage lender 104 each have separate accounts (i.e., user records) stored on server 100. In addition, available home buyer 105 and committed home buyer 106 each have separate accounts (i.e., client records) stored on server 100. Any of users 102-106 may access server 100 using any computer terminal with a web connection. Realtor 102 may also access server 100 using mobile device 107. Examples of suitable mobile devices include a PDA and a cell phone.

Once the identity of the user is determined from the login information, server 100 presents the user with an implementation of a programming interface (113-117). The programming interface is a means by which the user is able to interact with server 100. For example, the programming interface may be implemented as an application programming interface (API).

For example, realtor interface 113 is an implementation of a programming interface that allows server 100 to interact with realtor 102, such as by receiving input from realtor 102. Such input may include data, instructions for performing calculations or otherwise accessing realtor functionality 118 (see below), and requests for the generation of output. Mobile realtor interface 114 may be similar to realtor interface 113 (but designed to interact with mobile devices), or may be a modified implementation, allowing server 100 to receive a subset of such input from realtor 102. Similarly, financial planner interface 115 is an implementation of a programming interface that allows server 100 to interact with financial planner 103. Similarly, mortgage lender interface 116 is an implementation of a programming interface that allows server 100 to interact with mortgage lender 104. Similarly, home buyer interface 117 is an implementation of a programming interface that allows server 100 to interact with available home buyer 105 or committed home buyer 106.

Interfaces 113-117 allow users 102-106 to access the tools (also, “functionalities”) and the data that are available to the particular type of user. For example, server 100 receives the login information of realtor 102 and provides access to realtor functionality 118 via realtor interface 113 (or 1 14). Realtor functionality 118 includes, for example, the following tools: tax module; buying power module; buying up module; budgeting module; analysis module; comparison module; projection module; and investment module. Further details regarding these modules are provided below. Realtor interface 113 also allows realtor 102 to access data that is relevant to realtor 102. This includes all data specific to the client records created by realtor 102, as well as data relevant to users that have been identified by realtor 102 as collaborating professionals. Furthermore, realtor 102 is allowed access to realtor relevant data of clients not owned by realtor 102, but clients whose client record realtor 102 has been added to as a collaborating professional by the client owner.

For example, server 100 receives the login information of financial planner 103 and provides access to financial planner functionality 119 via financial planner interface 115. The user interface will display links to the tools available to financial planners, and may further have a variety of fields which may be populated by any of the data previously entered by financial planner 103 or by any of the users in a collaboration with financial planner 103. The tools available in financial planner functionality 119 may include any or all of the tools mentioned above.

As a further example, server 100 receives the login information of mortgage lender 104 and provides access to mortgage lender functionality 120 via mortgage lender interface 116. The user interface will display links to the tools available to mortgage lenders, and may further have a variety of fields which may be populated by any of the data previously entered by mortgage lender 104 or by any of the users in a collaboration with mortgage lender 104. The tools available in mortgage lender functionality 120 may include any or all of the tools mentioned above.

As a further example, server 100 receives the login information of buyer 105 or 106 and provides access to home buyer functionality 121 via home buyer interface 117. The user interface will display links to the tools available to home buyers, and may further have a variety of fields which may be populated by any of the data previously entered by home buyer 105 or 106 or by any of the users in a collaboration with such buyers. The tools available in home buyer functionality 121 may include any or all of the tools mentioned above.

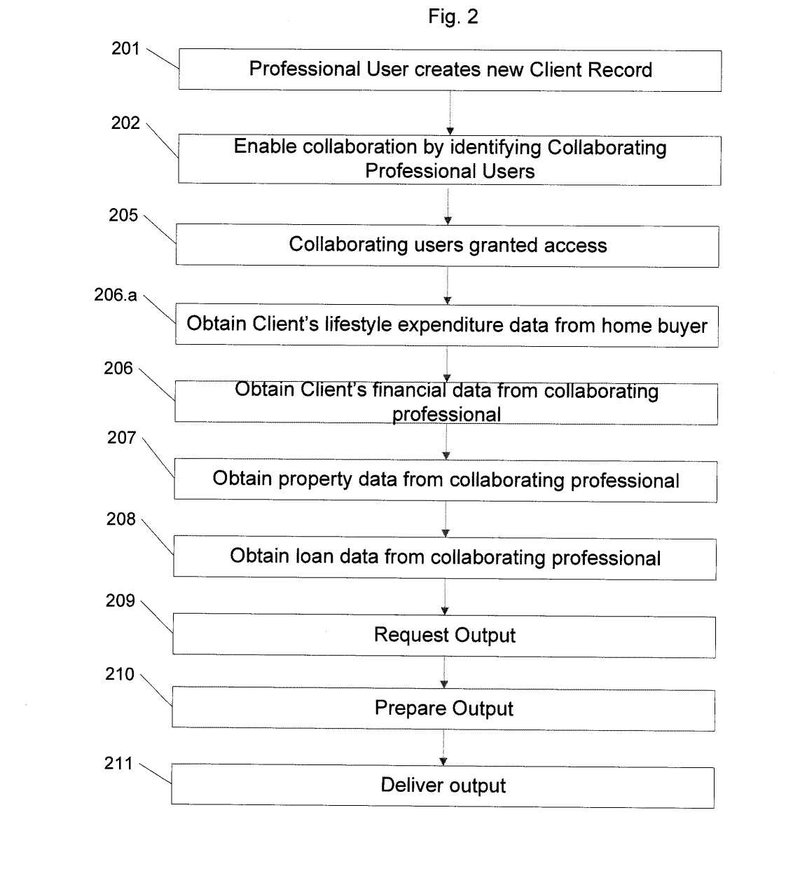

FIG. 2 is a flowchart that depicts obtaining, processing, and outputting data. Referring to FIGS. 1 and 2, a professional user such as realtor 102 accesses server 100. The realtor interface 113 and realtor functionality 118 allow realtor 102 to create a new client record (step 201) such as for committed home buyer 106 at which point the client records database is updated to include the new client record. The new client record presents realtor 102 with a number of fields for inputting a variety of data. At the point of creation of a client record, many of these fields may be automatically populated by server 100 with default global variables of realtor 102. Realtor 102 designates the new client record as allowing collaboration by, for example, selecting one or more professional users from the realtor 102's personalized list of collaborating professionals stored in the collaboration table to collaborate with on the client (step 202). Upon designating the client record as allowing collaboration, the client record on server 100 is updated with the identity of collaborating professionals who may view the client record. For example, realtor 102 may select mortgage lender 104 and financial planner 103 as collaborating professionals for buyer 106. Server 100 adds the identity of mortgage lender 104 and financial planner 103 to the client record thereby granting access to the client record by these collaborating professionals (step 205). Server 100 allows mortgage lender 104 and financial planner 103 to access the client record and updates various fields within the client record according to their role in the real estate transaction (step 206, 207, 208). For example, a value for the field “primary loan interest rate” may be obtained from mortgage lender 104 and a value for the field “investment rate of return” may be obtained from financial planner 103. Furthermore, server 100 populates various fields within the client record using data obtained from the committed home buyer 106 (step 206.a) using a computer terminal with a web connection. For example, values for the “lifestyle expense” fields may be obtained from the committed home buyer 106.

Realtor 102 may enter one or more of the financial data that is stored in the client record for buyer 106 (step 206). Alternatively, such data may be entered by any of the collaborating professional users identified in step 202. Realtor 102 may also enter one or more pieces of data pertaining to a property that realtor 102 identifies as potentially suitable for buyer 106 (step 207). Such data may include, for example, a Multiple Listing Service (MLS) identifying number. If an MLS number is entered, server 100 may import the property data from an MLS database accessible over the web. Alternatively, realtor 102 may enter the data “manually” (i.e., without importing it from an MLS database). The property data entered may be actual data (i.e., pertaining to a property actually for sale), or may be hypothetical data (i.e., estimates of a property price, etc.). Hypothetical data may be used, for example, in instances where buyer 106 is seeking guidance on the ideal property price for his financial circumstances.

Loan data may be entered by a collaborating user such as mortgage lender 104 (step 208). Again, such data may be actual data (e.g., interest rates and loan terms of a loan for which buyer 106 has actually qualified) or hypothetical data (e.g., estimates of interest rates and loan terms). Alternatively, the data may be entered by the client owner for buyer 106.

Any of the users with access to the client record for buyer 106 may request an output (step 209). Such a request may be made by selecting an appropriate option in the user interface, for example by selecting an icon or selecting a choice from a drop-down menu. When the user has indicated that an output is desired, the user interface may present the user with a number of options for data that can be included in the output. For example, the user may indicate that a comparison of two properties is desired as output, or that an analysis of a buyer's “buying power” (i.e., the maximum property purchase price that the buyer can afford) is desired. Based on the user's request for output, server 100 calculates the values required for the requested output (step 210) based on the loan data, property data, financial and investment data, and expenditure data provided by collaborating professionals 102, 103, 104, 105 and buyer 106. The user may also select from a plurality of languages based on the language the ultimate recipient of the output is most comfortable with. Server 100 formats the output according to the type and language of output requested, and delivers the output (step 211). For example, delivery of the output may be accomplished via a computer terminal monitor, or the output may be printed, or sent to realtor 102 or buyer 106 as an email or text message.

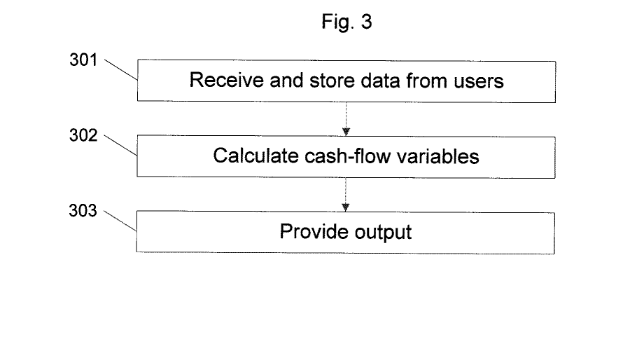

FIG. 3 is a flowchart that depicts a process for collaborating. In one implementation, the process includes electronically receiving data from a plurality of users (step 301). The data may be any of the data described herein; for example, the data may be selected from buyer income, buyer expenditures, buyer investment objectives, buyer retirement objectives, property purchase price, down payment, mortgage amount, mortgage term, loan discount rate, investment rate of return, investment allocation, desired net worth, property sale price, property and hazard insurance rates, property tax rates, property association dues, rental income, rental maintenance and vacancy rates, mortgage amounts, mortgage insurance rates, mortgage interest rate, mortgage term, mortgage type, professional commission rates, buyer Federal and State taxable income from a prior year's tax returns, buyer Federal and State tax liabilities from a prior year's tax returns, and buyer tax filing status. The plurality of users may be any of the users described herein; for example, the plurality of users may be selected from buyers, real estate agents, mortgage lenders, and financial planners. The received data is used to calculate one or more buyer-personalized cash flow variables (step 302). The one or more buyer-personalized cash flow variables may be any of the cash flow variables described herein; for example the cash flow variables may be selected from mortgage interest payments, mortgage principal payment, real estate tax payments, property and hazard insurance payments, home owner association payments, mortgage insurance premium payments, federal income tax benefits, state income tax benefits, projected aggregate housing expenses, projected net worth, comparisons of projected net worth between a plurality of investment options and a summation of income, Federal tax benefits, State tax benefits, rental income, housing expense, summation of income, and lifestyle expenditures. For example, the summation of all of a client's income, tax benefits, and expenditures for a specific property/loan may be calculated to demonstrate how much or little money the client will have left over as a result of a home/loan purchase. The one or more of the buyer-personalized cash flow variables are then provided in an output (step 303). The output may be any of the forms disclosed herein; for example, the output may comprise a personalized monthly cash flow report.

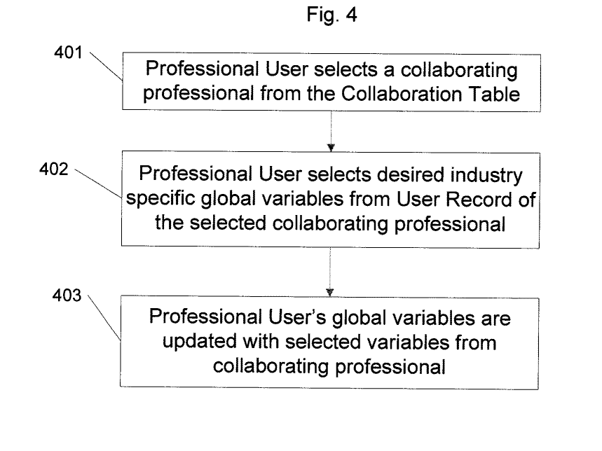

FIG. 4 is a flowchart that depicts the sharing of industry specific information between groups of collaborating professionals for the purpose of importing estimated financial variables into a newly created client record. Referring to FIGS. 1 and 4, a professional user, such as a realtor 102, accesses server 100. The realtor interface 113 and realtor functionality 118 allow realtor 102 to view and copy the global variables of other collaborating professionals from within the collaborating professional's user record. The collaborating professionals from whom realtor 102 may copy global variables are those professionals stored in realtor 102's personalized list of collaborating professionals in the collaboration table. For example, realtor 102 may select mortgage lender 104 and financial planner 103 from realtor 102's list of collaborating professionals from the collaboration table to import default values from their user records relevant to their respective industries (step 401). Realtor 102 may select a default value for the global variable field “property insurance multiplier” from the global variables of mortgage lender 104 and a default value for the global variable field “retirement account rate of return” from the global variables of financial planner 103 (step 402). Server 100 updates the global variables in realtor 102's user record with the selected values (step 403).

The use of multiple interfaces available to different professional users and homebuyers provides for a method to generate “lead generation” revenue. When server 100 is used by a professional user when working with a particular committed homebuyer, server 100 may track values provided by the professional user for variables such as the committed homebuyer's credit score, income, and location. For instance, when a professional user (e.g. collaborating mortgage lender X) provides an interest rate of 5.0% on a 30 year fully amortized loan for a committed homebuyer making $100,000 per year with a credit score of 700 in San Jose Calif., server 100 may determine that mortgage lender X can provide the same rate for the same loan program to any other homebuyer in San Jose Calif. (or located within an area that includes San Jose Calif.) with a credit score of 700 (or a credit score within a range that includes such a score) and an income of $100,000 per year (or an income within a range that includes $100,000 per year). When an available homebuyer logs on to server 100, the server can use this information to advertise the current interest rates of local mortgage lenders, and automatically populate the available homebuyer's interest rate with the lowest of the available rates for the available homebuyer's income, credit score, and location. The available homebuyer can then generate cash flow analyses with real-world interest rates without having to first select a mortgage lender to collaborate with. While the homebuyer is generating his cash flow analyses, server 100 alerts the user to the interest rate being used for the analysis is available through mortgage lender X and expose the available homebuyer to mortgage lender X's web banner advertisement. If the available homebuyer chooses to contact mortgage lender X through clicking mortgage lender X's web banner advertisement, a “lead generation” fee can be charged to mortgage lender X. In some implementations, the following benefits may be achieved using the aforementioned process.

First, the disclosed process does not require that mortgage lenders manually provide the current interest rates that they offer for a particular loan. The disclosed process provides a more direct method of gathering market rate information by retrieving it directly from actual values that have been provided by a mortgage lender for a particular client, thereby reducing the work done by the mortgage lender to manually enter the rate data to an advertising system, and insuring that the rate is available to a consumer.

Second, the disclosed process dynamically provides interest rates for homebuyers to generate cash flow analyses. Previous processes advertise rates generally—i.e., without personalizing the rate information to a specific site visitor unless the site visitor manually submits financial and personal data into a set of mortgage calculators to generate output. These previous processes are cumbersome and prone to errors, and must be repeated each time the site visitor wishes to use the calculator. The processes described herein, on the other hand, may be used to address such drawbacks by allowing sharing of data between professional users such as mortgage lenders and homebuyers.

The methods and systems discussed herein provide individuals and companies a medium through which they can collaborate to help those interested in the purchase of real estate. Although the methods disclosed herein are described with respect to purchases of residential real estate, it will be appreciated that the methods also apply to purchases of commercial real estate.

The subject matter described herein may be embodied in systems, apparatus, methods, and/or articles depending on the desired configuration. In particular, various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, applications, components, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal.

Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

What is claimed is:

1. A method comprising:
electronically receiving data from a plurality of users, wherein the data is selected from one or more of the following: an income, an expenditure, a property price, a mortgage interest rate, and a mortgage term;
calculating one or more buyer-personalized cash flow variables based on the received data, wherein the one or more buyer-personalized cash flow variables are selected from one or more of the following: a mortgage interest payment, a real estate tax payment, a property insurance payment, a home owner association payment, a mortgage insurance premium payment, a federal income tax benefit, a state income tax benefit, and a projected aggregate housing expense; and
providing an output, wherein the output includes the buyer-personalized cash flow variables formatted as a personalized monthly cash flow report.

2. The method of claim 1, wherein the receiving is carried out by a computer terminal connected to a network.

3. The method of claim 1, wherein the calculating is carried out by a computer processor.

4. The method of claim 1, wherein the providing is carried out by a computer output device.

5. The method of claim 1, wherein the method further comprises receiving data from, or outputting data to, a source selected from search engines, financial planning companies, mortgage brokers, and real estate brokers.

6. The method of claim 1, wherein the plurality of users are selected from mortgage lenders, financial advisors, realtors, committed home buyers, and available home buyers.

7. The method of claim 6, wherein the method further comprises providing a user interface, wherein the user interface comprises data fields that are customized for the user.

8. The method of claim 7, wherein when the user is a home buyer, the user interface comprises an interest rate data field for outputting interest rates received from a second user.

9. The method of claim 8, wherein the second user is a mortgage lender, and wherein the interest rate data field is capable of outputting an interest rate that is customized for financial variables provided by the home buyer.

10. The method of claim 9, wherein the financial variables provided by the home buyer are selected from income, location, and credit score.

11. A method comprising:
electronically receiving data selected from one or more of the following: an income, an expenditure, a price of a property for sale, and a term of a mortgage;
electronically storing the data in a data structure accessible to a plurality of users such that the plurality of users add and modify the data;
processing the data to calculate one or more cash-flow variables; and
producing an output including the calculated cash-flow variables,
wherein the cash-flow variables are selected from one or more of the following: a mortgage payment, a real estate tax payment, a property insurance payment, a homeowner association dues, a mortgage insurance payment, an income tax benefit, and a net monthly housing expense.

12. The method of claim 11, wherein the data structure is accessible to a search engine.

13. The method of claim 11, wherein the plurality of users are selected from mortgage lenders, financial advisors, realtors, committed home buyers, and available home buyers.

14. The method of claim 13, wherein the data comprises a mortgage interest rate, and wherein the mortgage interest rate is received from a mortgage lender.

15. The method of claim 14, further comprising associating the mortgage interest rate with one or more variables selected from a homebuyer income, a homebuyer credit score, and a homebuyer location.

16. The method of claim 15, further comprising receiving data from an available homebuyer and providing the mortgage interest rate to the available homebuyer in the output.

17. The method of claim 16, wherein the output further comprises an advertising banner provided by the mortgage lender, and wherein the method further comprising incrementing an advertising frequency variable associated with the mortgage lender.

18. An article comprising a tangible machine-readable storage medium embodying instructions that when performed by one or more processors result in operations comprising:
electronically receiving data from a plurality of users, wherein the data is selected from one or more of the following: an income, an expenditure, a property price, a mortgage interest rate, and a mortgage term;
calculating one or more buyer-personalized cash flow variables based on the received data, wherein the one or more buyer-personalized cash flow variables are selected from one or more of the following: a mortgage interest payment, a real estate tax payment, a property insurance payment, a home owner association payment, a mortgage insurance premium payment, a federal income tax benefit, a state income tax benefit, and a projected aggregate housing expense; and
providing an output, wherein the output includes the buyer-personalized cash flow variables formatted as a personalized monthly cash flow report.

19. The article of claim 17, wherein the plurality of users are selected from mortgage lenders, financial advisors, realtors, committed home buyers, and available home buyers.

20. A system comprising:
a processor; and
a memory, wherein the processor and the memory are configured to provide a method comprising:
receiving data from a plurality of users, wherein the data is selected from one or more of the following: an income, an expenditure, a property price, a mortgage interest rate, and a mortgage term;
calculating one or more buyer-personalized cash flow variables based on the received data, wherein the one or more buyer-personalized cash flow variables are selected from one or more of the following: a mortgage interest payment, a real estate tax payment, a property insurance payment, a home owner association payment, a mortgage insurance premium payment, a federal income tax benefit, a state income tax benefit, and a projected aggregate housing expense; and
providing an output, wherein the output includes the buyer-personalized cash flow variables formatted as a personalized monthly cash flow report.
